(19) United States
(12) Patent Application Publication
(10) Pub. No.: US 2018/0294590 A1
(43) Pub. Date: Oct. 11, 2018

(54) LIGHT DEVICE WITH ELECTRICAL CONTACT BETWEEN THE OUTER LENS AND THE HOUSING

(71) Applicant: VALEO VISION, Bobigny Cedex (FR)

(72) Inventors: Jean-Marc Colombel, Angers (FR); Francois Gratecap, Angers (FR)

(73) Assignee: VALEO VISION, Bobigny Cedex (FR)

(21) Appl. No.: 15/950,275

(22) Filed: Apr. 11, 2018

(30) Foreign Application Priority Data
Apr. 11, 2017 (FR) 17 53151

(51) Int. Cl. H01R 13/26; H01R 13/24; H01R 13/41; F21S 45/60

(52) U.S. Cl. CPC H01R 13/26; H01R 13/2464; H01R 2201/26; F21S 45/60; H01R 13/41

(57) ABSTRACT

A light signalling and/or lighting device including a housing with an opening and an outer lens fixed to the housing so as to close the opening. The device further includes at least one electrically conductive track on an inner face of the outer lens; and an electrical connector fixed to the housing and including at least one elastically mobile electrical contact pressing against the or one of the electrically conductive tracks so as to ensure an electrical contact with the track or tracks.

The invention deals with the field of lighting and light signalling for motor vehicles.

The use of light sources of light-emitting diode (LED) type is increasingly commonplace, primarily because of a better energy efficiency. That means that the light source or sources arranged in a light device produce substantially less heat compared to the more conventional light sources like the discharge and incandescent light sources. That also means that, in the case of formation of ice on the outer lens of a headlight equipped with light source(s) of LED type, the heat produced by said source or sources is likely to be insufficient to melt and clear the ice. It is then necessary to provide a specific de-icing device. Such a device is then arranged on the inner face of the outer lens and can comprise an electrically conductive and resistive coating such as metal wires, forming a heating zone when it is passed through by an electrical current. This heating zone must then be powered electrically by means of electrical tracks deposited on the inner face of the outer lens. Electrical power supply cables can be fixed to these electrical tracks in particular by soldering or by means of electrical connection plugs. Such an operation does however prove tedious in that it has to be performed before the outer lens is placed on the housing. Furthermore, once the wires are connected to the outer lens, the lengths of wires necessary to allow this operation while the outer lens is away from the housing have to be housed in the housing, which poses in particular problems of assembly time and bulk, not to mention any problems of reliability linked to the fact that these lengths of wires are likely to move freely in the housing.

The aim of the invention is to mitigate at least one of the drawbacks of the abovementioned prior art. More particularly, the aim of the invention is to produce an empowering of an electrical device, such as a de-icing device, on the inner face of the outer lens of a light device which is easy to implement, effective and reliable.

The subject of the invention is a light signalling and/or lighting device, comprising: a housing with an opening; an outer lens fixed to the housing so as to close the opening; noteworthy in that it also comprises at least one electrically conductive track on an inner face of the outer lens; and an electrical connector fixed to the housing and comprising at least one elastically mobile electrical contact pressing against the or one of the electrically conductive tracks so as to ensure an electrical contact with said track or tracks.

The number of electrically conductive tracks is advantageously greater than or equal to two, preferentially three.

Advantageously, the track or tracks are in electrical contact with a transparent coating on the inner face of the outer lens, forming a heating zone when it is passed through by an electrical current, in particular for de-icing purposes.

According to an advantageous mode of the invention, the connector and the electrically conductive track or tracks are configured for the placement of the outer lens on the housing to ensure the pressing of the elastically mobile electrical contact or contacts with said track or tracks.

According to an advantageous mode of the invention, the outer lens comprises, at its periphery, a rib engaging, in a direction of insertion, in a groove of the housing around the opening, the electrical contact or contacts being elastically mobile in a direction parallel and/or in a direction at right angles to the direction of insertion.

According to an advantageous mode of the invention, the or each of the elastically mobile electrical contacts is formed by a thin metal strip deformed by the pressing against the electrically conductive track on the outer lens.

According to an advantageous mode of the invention, the connector comprises a socket supporting the elastically mobile electrical contact or contacts.

According to an advantageous mode of the invention, the or each of the thin metal strips comprises a rounded front portion protruding from the socket and forming the electrical contact.

According to an advantageous mode of the invention, the rounded portion of the or each thin strip corresponds to a fold of said thin strip to more than 150° so as to exhibit a U section.

According to an advantageous mode of the invention, the electrical contact formed by the rounded portion of the or each thin strip comprises a rib extending over more than 150° of said portion. The rib forms the zone of contact with the electrically conductive track.

According to an advantageous mode of the invention, the or each of the thin metal strips comprises a generally rectilinear rear portion forming a hollow zone for receiving an electrical wire.

According to an advantageous mode of the invention, the or each of the thin metal strips comprises a central portion at right angles to the rear portion and comprising lateral wings engaging with corresponding grooves in the socket.

According to an advantageous mode of the invention, the portion or portions of electrically conductive track(s) pressing against the electrical contact or contacts is/are situated on a portion of the outer lens generally parallel and adjacent to a portion of wall of the housing forming the opening.

According to an advantageous mode of the invention, the socket forms a tongue parallel to the portion of wall and the portion of outer lens, and the or each of the thin metal strips exhibits a U profile fitted over said tongue.

According to an advantageous mode of the invention, the tongue comprises two opposing main faces, the or each of the thin strips comprising a domed portion on one of the main faces which is facing the outer lens, said domed portion pressing against the or one of the electrically conductive tracks.

According to an advantageous mode of the invention, the tongue is formed integrally with the portion of wall of the housing or is formed by a shield inside the housing.

According to an advantageous mode of the invention, the portion or portions of electrically conductive track(s) pressing against the electrical contact or contacts is/are situated on a portion of the outer lens transversal to a portion of wall of the housing forming the opening, the socket being fixed to a shield inside the housing.

The provisions of the invention are advantageous in that they make it possible to ensure a reliable electrical connection between the outer lens and the housing, and this despite an inevitable dispersion in the relative position between the outer lens and the housing as well as in the positioning of the electrical tracks relative to the outer lens and the connector relative to the housing. In effect, the fact that the electrical connection is made by one or more elastically mobile electrical contacts relative to the housing and pressing against the electrical track or tracks on the outer lens means that a certain tolerance is allowed, not only in the direction of deformation of the electrical contact or contacts but also in the direction of mounting of the outer lens on the housing in a direction transversal to the direction of mounting in the plane of the electrical track or tracks.

Other features and advantages of the present invention will be better understood from the description and the drawings in which:

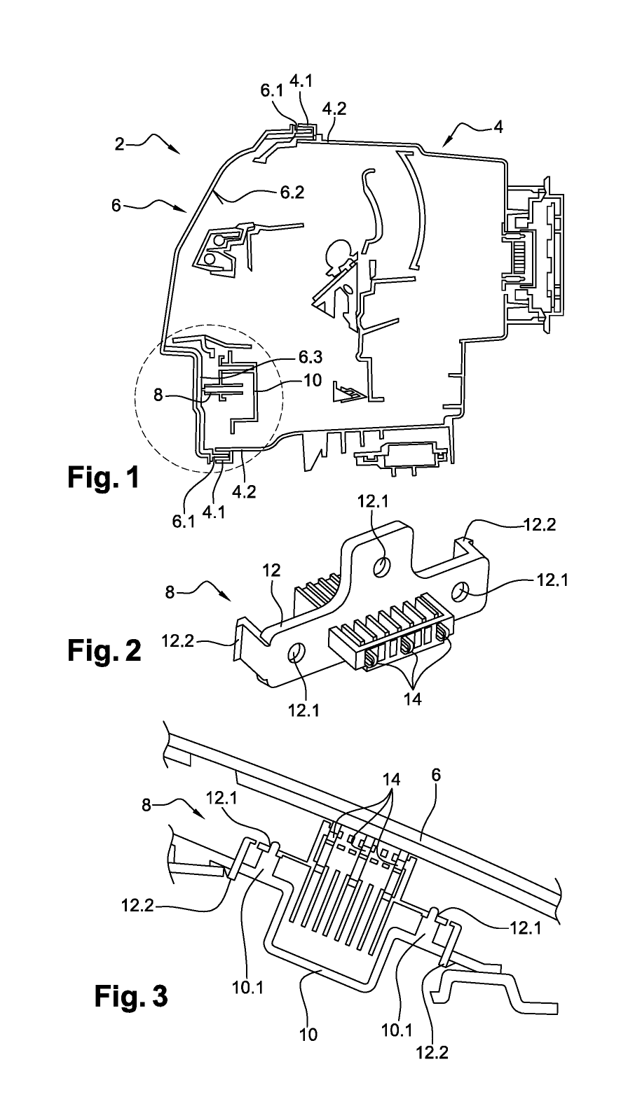

FIG. 1 is a view in longitudinal and vertical cross section of a lighting device according to a first embodiment of the invention;

FIG. 2 is a perspective view of the connector of the device of FIG. 1;

FIG. 3 is a view in horizontal cross section illustrating the contact between the connector and the outer lens of the device of FIG. 1;

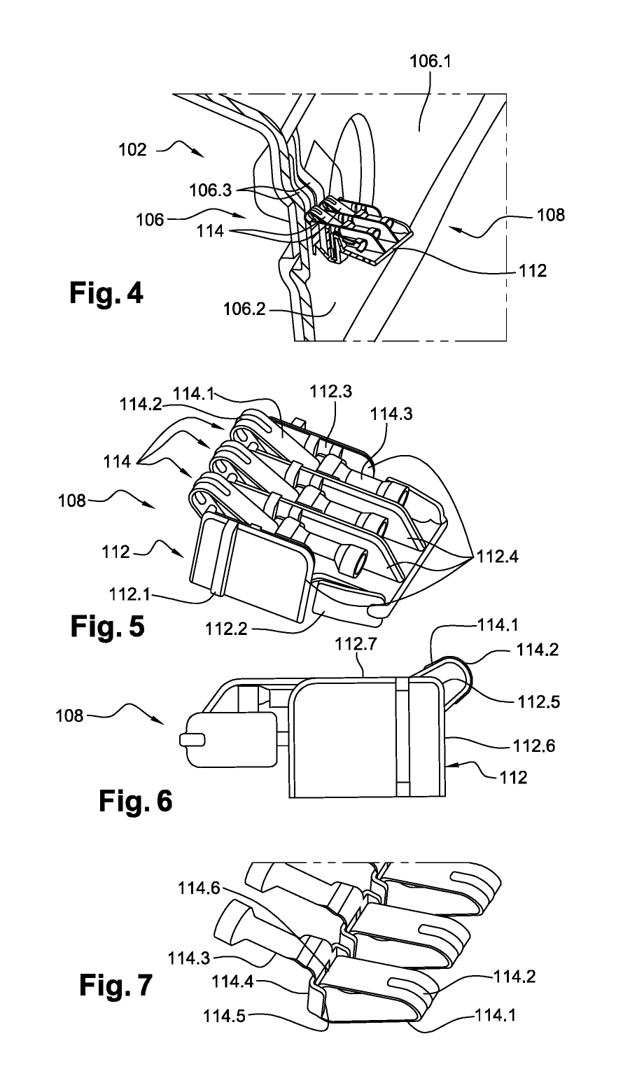

FIG. 4 is a perspective and cross-sectional view of a lighting device according to a second embodiment of the invention;

FIG. 5 is a perspective view of the connector of the device of FIG. 4;

FIG. 6 is a profile view of the connector of FIG. 5;

FIG. 7 is a perspective view of the thin metal strips of the connector of FIGS. 5 and 6;

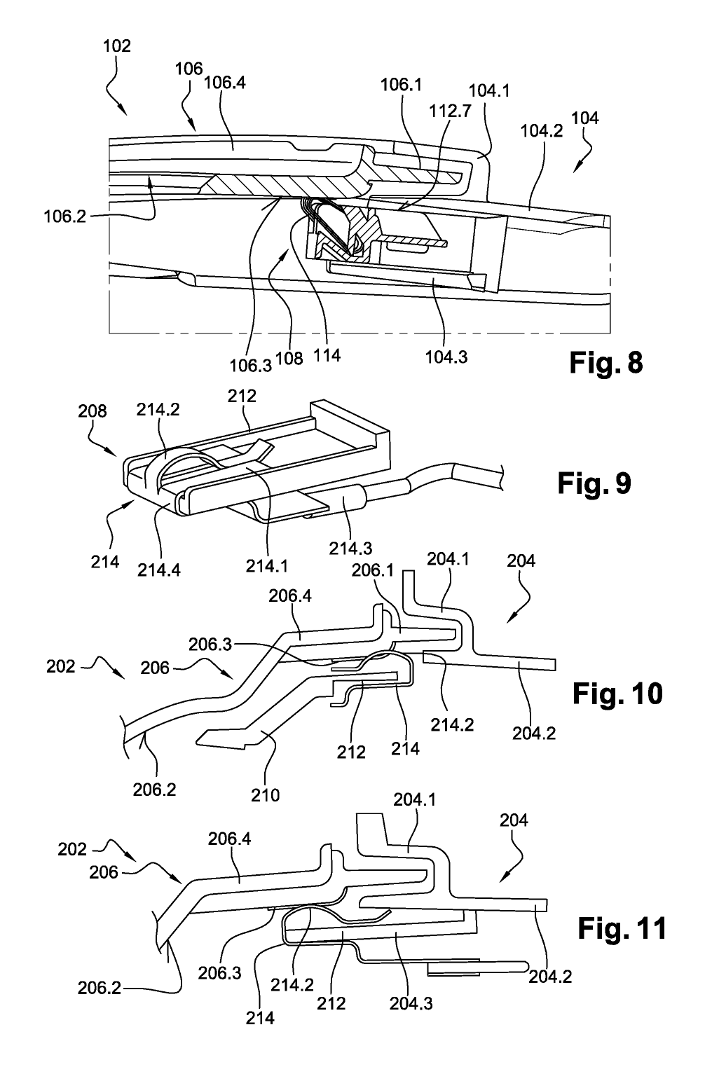

FIG. 8 is a perspective and cross-sectional view of an alternative configuration of the lighting device of FIG. 4;

FIG. 9 is a perspective view of a connector according to a third embodiment of the invention;

FIG. 10 is a cross-sectional view of a portion of lighting device provided with the connector of FIG. 9, according to a first variant of the third embodiment of the invention;

FIG. 11 is a cross-sectional view of a portion of lighting device provided with the connector of FIG. 9, according to a second variant of the third embodiment of the invention.

FIGS. 1 to 3 illustrate a first embodiment of the invention.

FIG. 1 is a view in longitudinal and vertical cross section of a lighting device, in this case a headlight, of a motor vehicle. The device 2 essentially comprises a housing 4 forming an opening, and an outer lens 6 assembled with the housing so as to close the opening concerned. The housing 4 encloses one or more light modules, as is known per se to the person skilled in the art.

The housing 4 comprises, at the periphery of the opening corresponding to the outer lens 6, one or more grooves 4.1 receiving a rib 6.1 of the outer lens 6, said rib extending on the periphery of the outer lens. This rib extends from the outer lens in a direction generally parallel to the portion of wall 4.2 of the housing forming the groove 4.1. This direction corresponds to the direction of placement of the outer lens 6 on the housing in the production operations. In this case, the ribs 6.1 can be produced by overmoulding of material on the transparent and main material of the outer lens 6, it being understood that it can also be made of a single piece with the transparent and main material of the outer lens 6.

The outer lens 6 comprises, on its inner face 6.2, an electrically conductive and resistive coating, forming a heating zone intended for the de-icing of the outer lens 6. This coating is not however visible in FIG. 1, because of its transparency and its small thickness. It is applied over a central and main portion of the outer lens, facing with respect to the light module or modules. The outer lens 6 also comprises on its inner face at least two electrical tracks 6.3 in electrical contact with the heating zone and extending towards the bottom of the outer lens. A connector 8 is arranged on an optical shield 10 then also ensuring a support role for the connector. The connector 8 comprises elastically mobile electrical contacts, in contact with and pressing against the electrical tracks 6.3 concerned.

The electrical contact between the electrical tracks 6.2 and the connector is produced in the assembly of the lighting device, more specifically upon the placement of the outer lens 6 on the housing 4. The direction of engagement of the rib 6.1 of the outer lens in the groove or grooves 4.1 of the housing corresponds to a direction of pressing of the electrical tracks 6.3 against the electrical contacts of the connector 8.

FIG. 2 shows a perspective illustration of the connector 8. It comprises a socket 12, advantageously made of plastic and electrically insulating material, and electrical contacts 14 mounted on the socket 12. The electrical contacts are advantageously formed by thin metal strips that are elastically deformable upon the placement of the outer lens on the housing, ensuring a contact pressure against the corresponding electrical tracks on the outer lens.

Still referring to FIG. 2, the socket can comprise positioning and fixing means, such as, in particular, orifices 12.1 used in the positioning of the socket in a plane at right angles to the direction of mounting of the outer lens on the housing, and/or retaining clips 12.2 intended to engage with the support of the connector and thus ensure the fixing thereof.

FIG. 3 is a cross-sectional view of the connector and of the portion of outer lens in contact with said connector. It can be seen that the shield 10 comprises positioning pins engaging with the orifices 12.1 of the socket of the connector 8. It can also be seen that the shield 10 comprises slits receiving the clips 12.2 of the socket concerned. It can be seen that the electrical contacts 14 of the connector 8 are against the inner face of the outer lens 6, more specifically against the corresponding electrical tracks (not visible).

FIGS. 4 to 8 illustrate a second embodiment of the invention. The reference numbers of the first embodiment are used to denote the identical or corresponding elements, that these numbers being uprated by 100. Also, reference is made to the description of these elements in the context of the first embodiment.

FIG. 4 is a cross-sectional view of a bottom part of a lighting device according to the second embodiment of the invention. It can be seen that the inner face of the outer lens 106 is provided with several electrical tracks 106.3 parallel to one another. In FIG. 4, only two tracks are visible because of the cross section, a third track being in fact present and not visible. The connector 108 comprises, like that of the first embodiment, a socket 112 made of plastic and electrically insulating material, and electrical contacts 114.

FIGS. 5 to 7 illustrate the connector 108 and the electrical contacts 114. The electrical contacts 114 are mounted on the socket 112. The latter can be configured to be inserted on a support (not represented), like the first embodiment. In this case, the socket 112 can comprise ridges 112.1 forming stopping surfaces on the support, and slat-fitting 112.2 intended to be deformed and engage with the support upon the insertion of the socket.

It can also be seen that each electrical contact 114 is formed by folding from an electrically conductive thin metal strip. Each electrical contact 114 comprises a front portion 114.1 protruding from the socket 112. The thin metal strip forms a rounding on the front portion 114.1 of more than 150°, preferentially close to 180°. The front portion 114.1 can moreover comprise, on the rounding, a rib 114.2 intended to form the zone of electrical contact as such. The rib 114.2 extends longitudinally along the thin strip over all the rounding, advantageously at the centre of said thin strip. The front portion 114.1, more specifically the rib 114.2 of each of the electrical contacts, can comprise a coating based on silver so as to avoid corrosion and thus ensure the electrical contact. The same applies for the electrical tracks.

Each electrical contact 114 can also comprise a rear portion 114.3 in a form of a rectilinear tube capable of receiving an end of an electrical wire for an electrical connection with said wire.

Each electrical contact 114 can also comprise a central portion 114.4 (FIG. 7) extending essentially at right angles to the rear portion 114.3 and comprising two lateral wings 114.5 capable of engaging with corresponding grooves 112.3 (FIG. 5) which can be formed on walls or curves 112.4 parallel to one another and forming recesses for the electrical contacts 114.

Referring to FIG. 7, the front portion 114.1 extends from the end of the central portion 114.4 opposite the rear portion 114.3, in an inclined direction relative to the longitudinal direction of the rear portion 114.3, to then form the rounding and return to the central portion 114.4 at its junction with the rear portion 114.3. The end 114.6 of the return of the rounding of the front portion 114.1 is free and away from the junction between the central portion 114.4 and the rear portion 114.3. The front portion 114.1 thus has a zone of contact extending over more than 150° at the rounding and, moreover, is elastically deformable essentially at the junction with the central portion 114.4.

Referring to FIG. 6, the front portion 114.1 of each electrical contact 114 advantageously extends protruding from a corner 112.5 of the socket 112 so as to be able to contact a surface parallel to each of the two right-angled edges 112.6 and 112.7 forming the corner 112.5 concerned.

FIG. 8 illustrates a top portion of the lighting device 102 of FIG. 4 according to a complementary or alternative configuration. The outer lens 106 comprises, on a portion 106.4 adjacent to the rib 106.1 and to the groove 104.1 on the housing, and parallel to the portion of wall 104.2 of the housing supporting the groove 104.1, one or more electrical tracks 106.3 pressing against electrical contacts 114 of a connector 108 similar or identical to that of FIGS. 4 to 7. Unlike the electrical contacts produced in FIG. 4, the electrical contact or contacts produced here in FIG. 8 is/are with a portion of the outer lens 106.4 generally at right angles to the portion of outer lens of FIG. 4. More particularly, it is interesting to note that the electrical tracks 106.3 on the portion of outer lens 106.4 concerned are generally parallel to the longest edge 112.7 of the socket unlike FIG. 4 in which the electrical tracks are parallel to the smallest edge 112.6 (FIG. 6)

It can also be seen in FIG. 8 that the connector 108 is mounted in a recess 104.3 linked to the portion of wall 104.2 of the housing 104. In particular, the socket of the connector 108 can be mounted in the recess by an insertion movement followed by an engagement of the snap-fitting clips with corresponding surfaces on the recess.

FIGS. 9 to 11 illustrate a third embodiment of the invention. The reference numbers of the first and second embodiments are used to denote the identical or corresponding elements, these numbers however being uprated by 200 or 100, respectively. Referenced is also made to the description of these elements in the context of the first and second embodiments.

FIG. 9 illustrates the connector 208. The latter comprises a socket 212 in the form of a tongue with the electrical contact 214 fitted onto it. The latter is formed by a thin metal strip comprising a front or front-end portion 214.1 with a protruding narrower thin strip 214.2 intended to ensure the electrical contact with the corresponding electrical track. More specifically, the protruding thin strip 214.2 can be formed by cutting the front-end portion 214.1 and deforming to give it a curved form, preferably S-shaped, as can be seen in FIG. 9. It is interesting to note that the end of the protruding thin strip 214.2 is in contact with the surface of the socket 212, which gives the thin strip concerned an increased stiffness.

Still in FIG. 9, it can be seen that the electrical contact 214 comprises a rear portion 214.3 with a cylindrical zone intended to receive and fix an electrical cable.

The electrical contact 214 comprises a central portion 214.4 forming a U profile fitted over the end of the tongue 212.

FIG. 10 illustrates a first variant implementation of the connector of FIG. 9. It can be seen therein that the tongue 212 used as socket is formed directly on an optical shield 210. The latter being at least partially towards the front, and the tongue is directed towards the rear. The electrical contact 214 has its protruding thin strip 214.2 in contact with the electrical track 206.3 adjacent to the foot of the outer lens 206 provided with the rib 206.1.

FIG. 11 illustrates a second variant implementation of the connector of FIG. 9. It can be seen that the tongue 212 used as socket for the connector is this time directed towards the front and formed by a wall 204.3 supported by the portion of wall 204.2 adjacent to the groove 204.1 joining with the outer lens 206. Advantageously, the tongue is formed integrally, that is to say made of a single piece, with the portion of wall 204.2. The protruding thin strip 214.2 is in contact with the electrical track 206.3, like the first variant of FIG. 10, with the difference that the electrical contact 214 is oriented in the opposite way.

1. Light signalling and/or lighting device comprising:
a housing with an opening;
an outer lens fixed to the housing so as to close the opening;
wherein the device also comprises:
at least one electrically conductive track on an inner face of the outer lens; and
an electrical connector fixed to the housing and comprising at least one elastically mobile electrical contact pressing against the or one of the electrically conductive tracks so as to ensure an electrical contact with said track or tracks.

2. Device according to claim 1, wherein the connector and the electrically conductive track or tracks are configured for the placement of the outer lens on the housing to ensure the pressing of the elastically mobile electrical contact or contacts with said track or tracks.

3. Device according to claim 1, wherein the outer lens comprises, at its periphery, a rib engaging, in a direction of insertion, in a groove of the housing around the opening, the electrical contact or contacts being elastically mobile in a direction parallel and/or in a direction at right angles to the direction of insertion.

4. Device according to claim 1, wherein the or each of the elastically mobile electrical contacts is formed of a thin metal strip deformed by the pressing against the electrically conductive track on the outer lens.

5. Device according to claim 1, wherein the connector comprises a socket supporting the elastically mobile electrical contact or contacts.

6. Device according to claim 4, wherein the or each of the thin metal strips comprises a rounded front portion protruding from the socket and forming the electrical contact.

7. Device according to claim 6, wherein the rounded portion of the or each thin strip corresponds to a fold of said thin strip to more than 150° so as to exhibit a U section.

8. Device according to claim 6, wherein the electrical contact formed by the rounded portion of the or each thin strip comprises a rib extending over more than 150° of said portion.

9. Device according to claim 6, wherein the or each of the thin metal strips comprises a generally rectilinear rear portion forming a hollow zone for receiving an electrical wire.

10. Device according to claim 9, wherein the or each of the thin metal strips comprises a central portion at right angles to the rear portion and comprising lateral wings engaging with corresponding grooves in the socket.

11. Device according to claim 1, wherein the portion or portions of electrically conductive track(s) pressing against the electrical contact or contacts is/are situated on a portion of the outer lens generally parallel and adjacent to a portion of wall of the housing, said portion forming the opening.

12. Device according to claim 4, wherein the socket forms a tongue parallel to the portion of wall of the housing and the portion of outer lens, and the or each of the thin metal strips exhibits a U profile fitted over said tongue.

13. Device according to claim 12, wherein the tongue comprises two opposing main faces, the or each of the thin strips comprising a domed portion on one of the main faces which is facing the outer lens, said domed portion pressing against the or one of the electrically conductive tracks.

14. Device according to claim 12, wherein the tongue is formed integrally with the portion of wall of the housing or is formed by a shield inside the housing.

15. Device according to claim 1, wherein the portion or portions of electrically conductive track(s) pressing against the electrical contact or contacts is/are situated on a portion of the outer lens which is transversal to a portion of wall of the housing, forming the opening, the socket being fixed to a shield inside the housing.

16. Device according to claim 2, wherein the outer lens comprises, at its periphery, a rib engaging, in a direction of insertion, in a groove of the housing around the opening, the electrical contact or contacts being elastically mobile in a direction parallel and/or in a direction at right angles to the direction of insertion.

17. Device according to claim 2, wherein the or each of the elastically mobile electrical contacts is formed of a thin metal strip deformed by the pressing against the electrically conductive track on the outer lens.

18. Device according to claim 2, wherein the connector comprises a socket supporting the elastically mobile electrical contact or contacts.

19. Device according to claim 5, wherein the or each of the thin metal strips comprises a rounded front portion protruding from the socket and forming the electrical contact.

20. Device according to claim 7, wherein the electrical contact formed by the rounded portion of or each thin strip comprises a rib extending over more than 150° of said portion.
